(19) United States
(12) Patent Application Publication
(10) Pub. No.: US 2010/0033599 A1
(43) Pub. Date: Feb. 11, 2010

(54) IMAGE CAPTURE DEVICE WITH AUTO-CAPTURE FUNCTION AND AUTO-CAPTURE METHOD THEREOF

(75) Inventor: QI-DA GUAN, Foshan (CN)

Correspondence Address: PCE INDUSTRY, INC.;ATT. Steven Reiss, 288 SOUTH MAYO AVENUE, CITY OF INDUSTRY, CA, 91789, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/331,401

(22) Filed: Dec. 9, 2008

(30) Foreign Application Priority Data
Aug. 8, 2008 (CN) 200810303637.2

(51) Int. Cl. H04N 5/76

(52) U.S. Cl. 348/231.99

(57) ABSTRACT

An image capture device with auto-capture includes a capture unit and a self-timing unit. The capture unit is configured for capturing images. The self-timing unit is configured for counting down a predetermined interval, acquiring preview images of an object, locating and identifying a designated element of the object in the preview images, and comparing if the consecutive preview images are essentially similar, if so, performing the final image capture.

### BACKGROUND

1. Technical Field

The disclosure relates to image capture devices and, particularly, to an image capture device with auto-capture function and auto-capture method thereof.

2. Description of the Related Art

Most cameras provide a timed self-capture function, which generally, when enabled, implements a delay between activation and shutter operation, allowing self-portrait capture. However, the length of the delay is commonly preset. As a consequence, it can be inconvenient or difficult to accurately capture desired pose(s) or positioning with an inflexible preset delay time.

Therefore, it is desirable to provide an image capture device and auto-capture method which can overcome the described limitations.

### BRIEF DESCRIPTION OF THE DRAWINGS

FIG. 1 is a block diagram showing an image capture device, according to a first exemplary embodiment.

FIG. 2 is a flowchart showing an auto-capture method according to a second exemplary embodiment.

### DETAILED DESCRIPTION OF THE EMBODIMENTS

Embodiments of the image capture device and auto-capture method are described in detail here with reference to the drawings.

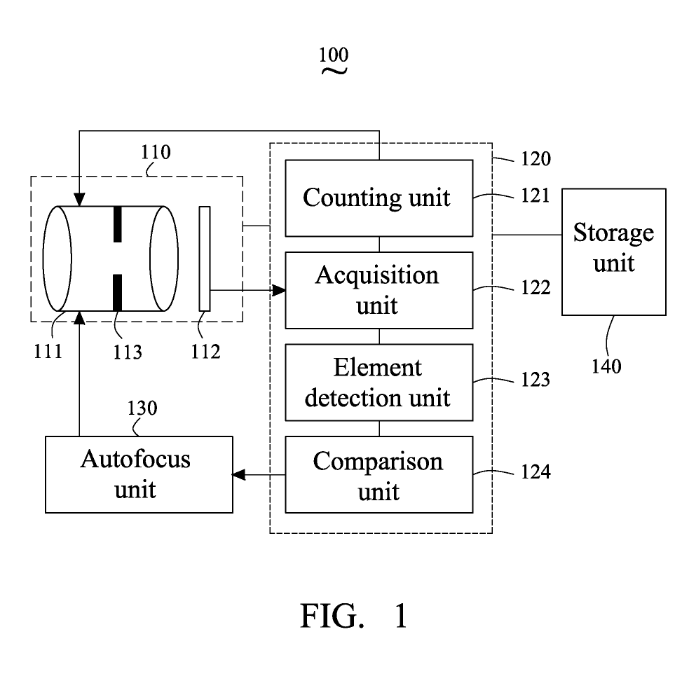

Referring to FIG. 1, an image capture device 100, according to a first exemplary embodiment, includes an image capture unit 110, an autofocus unit 130, an auto-capture system 120, and a storage unit 140. The image capture unit 110 is configured for capturing images. The autofocus unit 130 is configured for automatically focusing the image capture unit 110. The auto-capture system 120 is configured for automatically operating the image capture unit 110 to capture a final image.

The image capture unit 110 may include a lens unit 111, an image detection unit 112, and a shutter 113 embedded in the lens unit 111. The lens unit 111 has a focusing lens (not shown) and is configured for forming an optical image onto the image detection unit 112. The image detection unit 112 is configured for converting the optical image into a digital signal and outputting consecutive preview images before the shutter 113 is triggered, and the final image after the shutter 113 is triggered. The image detection unit 112 may be a charge-coupled device (CCD) image sensor or a complementary metal-oxide-semiconductor (CMOS) image sensor.

The autofocus unit 130 may include a step motor (not shown) and focus the image capture unit 110 by moving the lens unit 111 using the step motor based upon information from the preview images.

The auto-capture system 120 includes a counting unit 121, an acquisition unit 122, an element detection unit 123, and a comparison unit 124.

The counting unit 121 is configured for counting down a predetermined period and directing the image capture unit 110 to start output of preview images after the countdown is complete. The predetermined period is set by the user to obtain adequate time to complete the desired composition of the scene to be captured.

The acquisition unit 122 is configured for acquiring first and second preview images. An interval between the capture timing of the two preview images can be set by users to any suitable interval.

The element detection unit 123 is configured for locating and identifying a designated element in the first and the second preview images, utilizing different identification algorithms such as nerve network, nerve network plus fast Fourier transform, fuzzy plus nerve network, RGB normalized color, fuzzy color, principle component analysis, or algorithm template.

The comparison unit 124 is configured for comparing the designated element of the second preview image with that of the first preview image. If a match is found, for example, having substantially the same position, it is determined that the shutter 113 should be triggered to capture the final image. That is, if objects remain unmoved beyond the interval, the auto-capture system 120 deems composition complete and triggers the shutter 113.

The storage unit 140 stores the final image. The storage unit 140 may be a semiconductor memory, such as an electrically-erasable programmable read-only memory (EEROM), or magnetic random access memory (MRAM).

It should be mentioned that various components of the auto-capture system 120 such as the counting unit 121, the image acquisition unit 122, the element detection unit 123, and the comparison unit 124 can be individual electrical chips or integrated into a central control unit. They can also be software modules implemented by hardware to achieve corresponding functions. This auto-capture system 120 can be provided as an image capture mode of the image capture device 100.

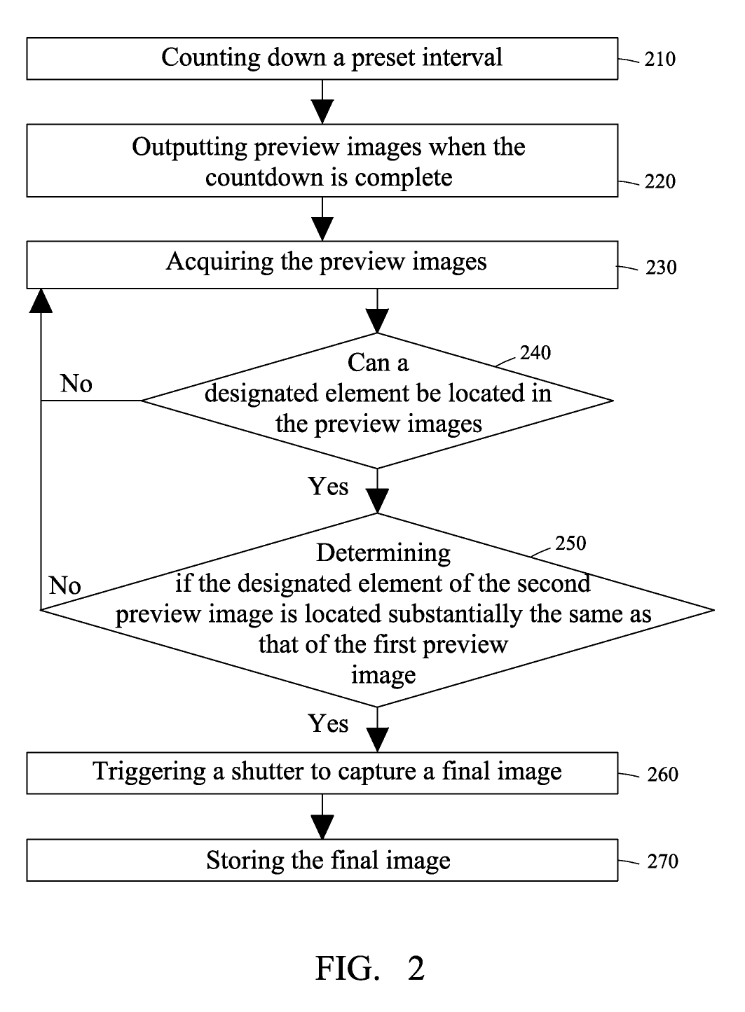

As shown in FIG. 2, an auto-capture method, according to a second embodiment, performed by the image capture device 100, is undertaken as follows.

In step 210, a preset interval is counted down. At this point, if a corresponding image capture mode provided by the auto-capture system 120 is selected, the auto-capture system 120 is initialized and generates a window allowing the predetermined time to be set. Any interval can be applied. For example, if a wide angle composition is to be captured, a longer time delay such as ten seconds can be set to allow the users to complete the composition of the scene to be captured.

In step 220, preview images are output from the image capture unit 110 when the countdown is complete. It is assumed that when the countdown is complete, the objects are settled and desirable composition acquired. This step is mainly carried out by the image capture unit 110, which can further include a buffer (not shown) temporarily storing the preview images.

In step 230, two of the preview images are acquired by the acquisition unit 122. These two preview images are samples for determining whether the composition is complete (see steps 240-250).

In step 240, a designated element is sought in the two preview images. If the designated element is found, step 250 is executed. If no designated element is found, step 230 is executed. The designated element can be a face or other feature of the object(s). It should be mentioned that before this step and preferably after step 210, autofocus has been carried out by the autofocus unit 130. Accordingly, high quality preview images, providing the basis for accurate element detection, can be obtained.

In step 250, it is to be determined if the designated element of the second preview image is sufficiently similar to that of the first preview image. If yes, step 260 is executed. If no match is found, step 230 is repeated. In the former case, the object(s) remain stationary for the interval, interpreted as a demonstration that a desirable composition is complete. On the other hand, in the latter case, composition is not yet complete. The comparison is executed by the comparison unit 124.

In step 260, the shutter 113 is triggered and the image capture unit 110 captures the final image.

In step 270, the final image is stored in a storage unit 130.

The auto-capture method executed by the image capture device 100 can determine whether the designated elements in the two preview images are substantially the same, and thereby whether capture should be executed.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image capture device with an auto-capture function, comprising:
an image capture unit configured for capturing images; and
an auto-capture system configured for counting down a predetermined interval, acquiring two preview images of an object, locating and identifying a designated element of the object in the preview images, comparing if the preview images have the same designated element located substantially the same, and performing a final image capture upon a condition that the preview images have the designated element located substantially the same.

2. The image capture device of claim 1, further comprising a storage unit configured for storing the final image.

3. The image capture device of claim 1, wherein the image capture unit comprises a lens unit, an image detection unit, and a shutter embedded in the lens unit; the lens unit is configured for projecting an optical image onto the image detection unit.

4. The image capture device of claim 3, wherein the image detection unit of the lens unit is configured for converting the optical image into a digital signal and outputting consecutive preview images before the shutter is triggered.

5. The image capture device of claim 3, wherein the image detection unit comprises a charge coupled device image sensor or a complementary metal-oxide-semiconductor image sensor.

6. The image capture device of claim 3, wherein the lens unit comprises a focusing lens.

7. The image capture device of claim 3, further comprising an autofocus unit, wherein the autofocus unit comprises a step motor and is configured for focusing the image capture unit by moving the lens unit via the motor upon information of the preview images.

8. The image capture device of claim 1, wherein the auto-capture system comprises a counting unit, an acquisition unit, an element detection unit, and a comparison unit; the counting unit is configured for counting the predetermined time, the acquisition unit is configured for acquiring two preview images of an object, the element detection unit is configured for locating and identifying the designated element of the object from the preview images, and the comparison unit is configured for comparing if the preview images have the designated element located substantially the same.

9. The image capture device of claim 2, wherein the storage unit is an electrically-erasable programmable read-only memory or magnetic random access memory.

10. An auto-capture method for an image capture device, comprising:
counting down a predetermined time;
acquiring two preview images of an object when the countdown is complete;
determining if a designated element of the object can be located in the preview images;
upon the condition that a designated element is located, comparing if the preview images have the designated element located substantially the same; and
upon the condition that the designated element is located substantially the same, triggering a shutter to capture a final image.

11. The auto-capture method of claim 10, wherein the acquiring step is performed upon the condition that a designated element cannot be.

12. The auto-capture method of claim 10, further comprising storing the final image in a storage unit.

13. The auto-capture method of claim 10, wherein the countdown is executed by a counting unit.

14. The auto-capture method of claim 10, wherein the acquisition is performed by an acquisition unit.

15. The auto-capture method of claim 10, wherein the designated element is sought by an element detection unit.

16. The auto-capture method of claim 10, further comprising focusing the image capture unit by moving the lens unit based on information from the preview images.

17. The auto-capture method of claim 10, wherein the determining step uses an identification algorithm.

18. The auto-capture method of claim 17, wherein the identification algorithm is selected from the group consisting of nerve network, nerve network plus fast Fourier transform, fuzzy plus nerve network, RGB normalized color, fuzzy color, principle component analysis, and algorithm template.
